(19) United States
(12) Patent Application Publication
(10) Pub. No.: US 2004/0146032 A1
(43) Pub. Date: Jul. 29, 2004

(54) Various network systems connecting facility

(76) Inventor: Alan Lin, Hsin Chuang City (TW)

Correspondence Address: Alan Lin, P.O. Box 4-67, Hsin Chuang, Taipei, 242, TW

(21) Appl. No.: 10/351,177

(22) Filed: Jan. 23, 2003

(51) Int. Cl. H04Q 7/24

(52) U.S. Cl. 370/338; 709/227

(57) ABSTRACT

A facility includes a network interface card device having an interface for coupling to and communicating with a computer, a processor device coupled to the interface, a coupler and an antenna coupled to the processor device, and a subscriber identify module (SIM) card for coupling to the coupler of the network interface card device, and to connect to network systems. With the SIM card, the users may readily communicate with various network systems without renting LAN cards or WLAN cards from the ISPs, and without preparing or coupling the other antenna devices.

### BACKGROUND OF THE INVENTION

1. Field of the Invention

The present invention relates to a network system connecting facility, and more particularly to a facility for connecting to various network systems.

2. Description of the Prior Art

Typically, various kinds of internet service providers (ISP) may provide services to couple or to connect end users to various network systems. Each ISP provide different service ranges or areas, different service natures or qualities or functions, and different charges, etc.

The end users have to open an account in the ISP, or to rent a local area network (LAN) card or wireless local area network (WLAN) card from the ISP, in order to couple or to connect to various network systems.

However, when the end users have changed to the ranges or areas of the other ISPs, the end users may have a great trouble to connect to the new or different or other ISPs that they are used before.

The present invention has arisen to mitigate and/or obviate the afore-described disadvantages of the conventional methods or processes for connecting between the end users and the ISPs.

### SUMMARY OF THE INVENTION

The primary objective of the present invention is to provide a facility for facilitating connection of various end users to various network systems via different ISPs.

The other objective of the present invention is to provide a facility for connecting to various network systems with subscriber identify module (SIM) card.

In accordance with one aspect of the invention, there is provided a facility for network system connecting purposes, the facility comprising a computer, a network interface card device for coupling to the computer, the network interface card device including an interface for coupling to and communicating with the computer, a processor device coupled to the interface, a coupler coupled to the processor device, and an antenna coupled to the processor device, and a subscriber identify module (SIM) card for coupling to the coupler of the network interface card device, and to connect to network systems. With the SIM card, the users may easily and readily connect and communicate with various network systems without renting local area network (LAN) cards or wireless local area network (WLAN) cards from the ISPs, and without preparing or purchasing and plugging or coupling the other antenna devices.

The network interface card device is preferably a wireless network interface card device. The network interface card device includes a wireless module coupled between the processor device and the antenna.

A local area network system is further provided and includes an access or device to connect and communicate with the network interface card device via the antenna.

Further objectives and advantages of the present invention will become apparent from a careful reading of the detailed description provided herein below, with appropriate reference to the accompanying drawings.

### BRIEF DESCRIPTION OF THE DRAWINGS

FIG. 1 is a plan schematic view illustrating a network system connecting facility in accordance with the present invention;

FIG. 2 is an exploded and schematic view illustrating the connecting of end users to network systems;

FIG. 3 is a flow chart illustrating the coupling of an SIM card to a computer; and

FIG. 4 is a flow chart illustrating the coupling of an end user to a network system.

### DETAILED DESCRIPTION OF THE PREFERRED EMBODIMENT

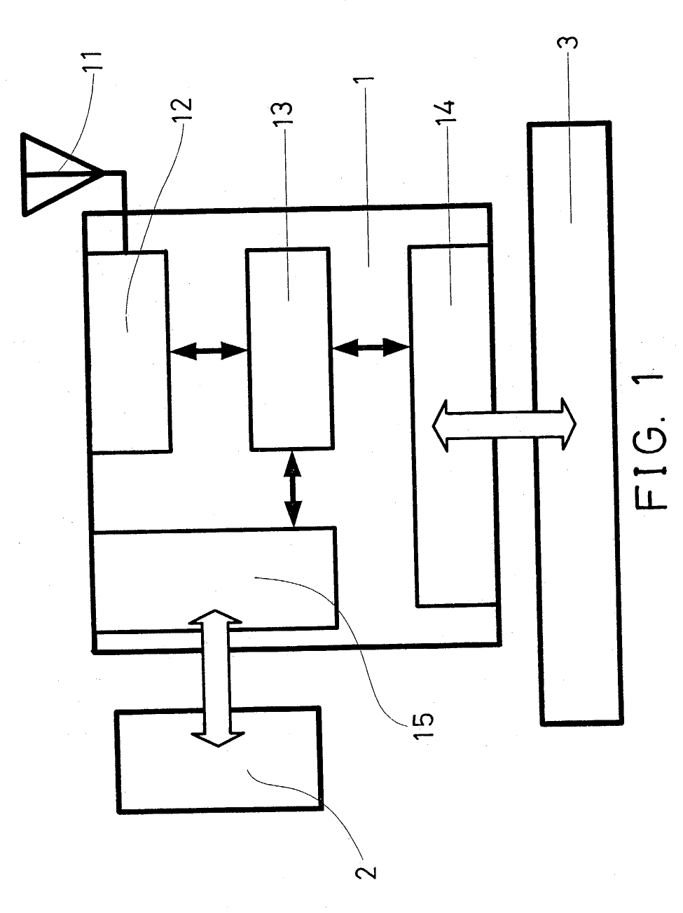

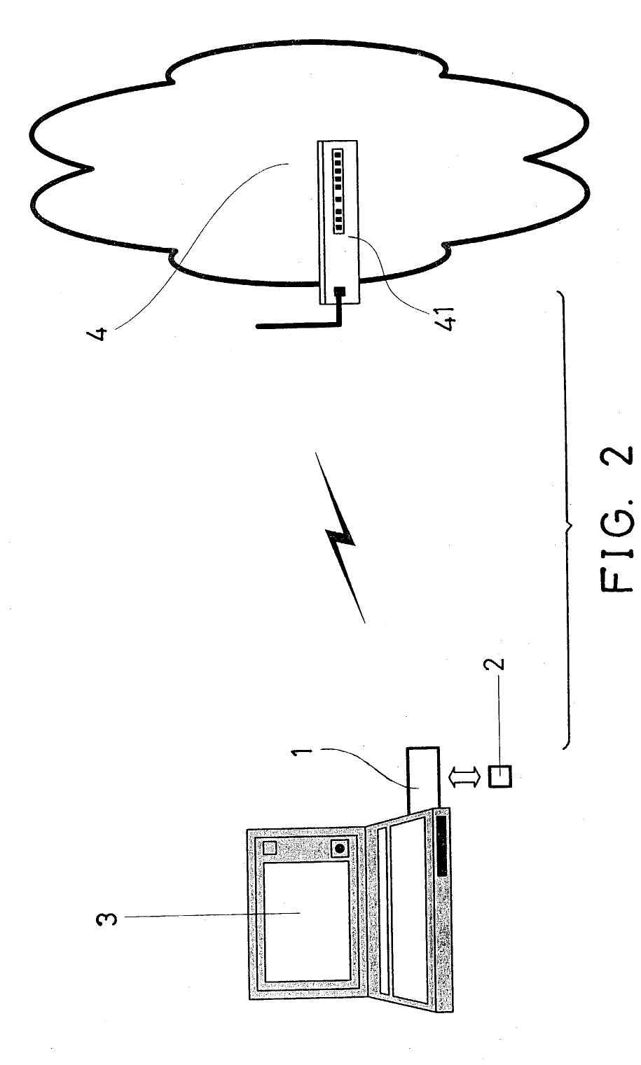

Referring to the drawings, and initially to FIGS. 1 and 2, a facility in accordance with the present invention is provided for allowing end users or various computers 3 to couple or to connect to various local area network (LAN) systems or wireless local area network (WLAN) systems 4 or ISPs.

The facility comprises a network interface card device 1, particularly a wireless network interface card device 1 for plugging or coupling to various computers, such as notebook computers 3 (FIG. 2). For example, the wireless network interface card device 1 includes an interface 14 (FIG. 1) or interface card for coupling to and for communicating with the computer 3. The interface 14 may be any suitable interfaces, such as personal computer memory card international association (PCMCIA), universal serial bus (USB), etc.

The wireless network interface card device 1 further includes a processor unit or device 13 coupled to the interface 14 thereof, for processing signals or information, and a wireless module 12 coupled to the processor device 13, and an antenna 11 coupled to the wireless module 12, for receiving or transmitting signals, such as the signals of 802.11 of institute of electrical and electronic engineers.

In operation, the antenna 11 may transmit signals or information to and from the WLAN systems 4, for communicating between the end users or computers 3 and the WLAN systems 4. The wireless module 12 may be used to convert signals and to communicate between the antenna 11 and the processor device 13.

As shown in FIG. 1, the wireless network interface card device 1 further includes a slot or a coupler 15 provided therein and coupled to the processor device 13, for plugging or for coupling to a subscriber identify module (SIM) card 2 (FIG. 2).

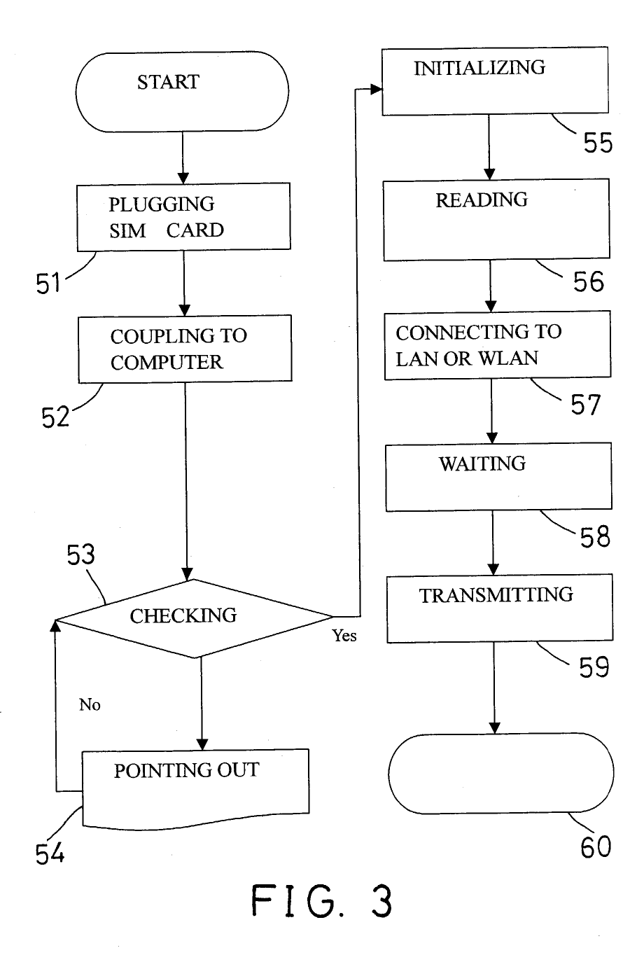

In operation, as shown in FIG. 3, when in use or while operating the facility in accordance with the present invention, the SIM card 2 is first plugged or coupled to the wireless network interface card device 1 in process 51, for coupling to the computer 3 in process 52, and for allowing the signals or messages or information to be transmitted from the SIM card 2 to the processor device 13 of the computer 3.

A checking process 53 may then be conducted to check whether the SIM card 2 has been correctly or suitably coupled to the wireless network interface card device 1 or not. If the SIM card 2 has not been suitably coupled to the wireless network interface card device 1, a pointing out process 54 may be conducted to remind the users that the SIM card 2 has not been suitably coupled to the wireless network interface card device 1.

If the SIM card 2 has been checked to be suitably coupled to the wireless network interface card device 1, an initializing process 55 may then be conducted to start communicating with the SIM card 2, and to read the signals or messages or information from the SIM card 2 at process 56, such as to read passwords, service set identifier (SSID) from the SIM card 2.

The processor device 13 of the wireless network interface card device 1 may then proceed to connect to various LAN or WLAN systems 4 at process 57, for sending out the passwords, service set identifier (SSID) or other information from the SIM card 2 to the LAN or WLAN systems 4. The end users 3 may then have to wait at process 58, until the passwords, service set identifier (SSID) or other information from the SIM card 2 has been checked or identified by the LAN or WLAN systems 4.

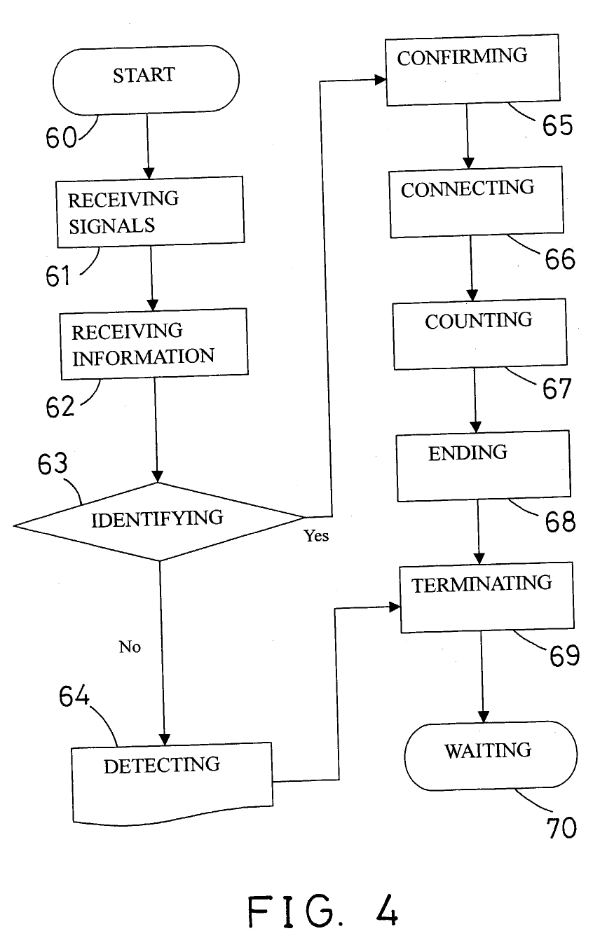

After the information from the SIM card 2 has been checked or identified, the LAN or WLAN systems 4 may include an access or device 41 to sent out confirmation signals to the end users 3, for allowing the end users 3 to communicate with and to transmit information to and from the LAN or WLAN systems 4, at process 59, until the communication or connection between the end users 3 and the LAN or WLAN systems 4 has been ended or completed at process 60 (FIG. 3), and/or until the processing of the LAN or WLAN system 4 side has been started at process 60 (FIG. 4).

Referring nest to FIG. 4, in the LAN or WLAN system 4 side, the access or device 41 of the LAN or WLAN system 4 may first to receive signals and/or information or signals, such as passwords, service set identifier (SSID) from the end users 3, in processes 61, 62, and then to identify whether the information or passwords or SSID from the end users 3 is correct or not, in process 63.

If the information or passwords or SSID from the end users 3 has been detected to be incorrect or wrong, in process 63, a detecting process 64 may then be conducted to detect which information has been wrong, and will then end or terminate the communication in process 69, and will then wait for the other end user to connect or to communicate with the LAN or WLAN system 4 in process 70.

On the contrary, when the information or passwords or SSID from the end users 3 has been detected to be correct or acceptable, in process 63, a confirming process 65 may then be conducted to confirm or to accept the end user 3, and then to connect or transmit or communicate with the end user at process 66. A counting process 67 may then be conducted to calculate or to count the processing time, information down load, charges, etc. from or between the end user 3 and the LAN or WLAN system 4, before the communication is ended in a process 68 or before terminating the communication 69.

It is to be noted that the provision and attachment of the SIM card 2 to the wireless network interface card device 1 allows the users to easily and readily connect to various network systems, without opening any account in the ISPs, and without renting local area network (LAN) cards or wireless local area network (WLAN) cards from the ISPs.

In addition, the wireless network interface card device 1 includes an antenna 11 for allowing the users to easily and readily connect to various network systems without preparing or purchasing and plugging or coupling the other antenna devices.

Accordingly, the facility in accordance with the present invention may be provided for facilitating connection of various end users to various network systems via different ISPs, with such as subscriber identify module (SIM) card.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A facility for network system connecting purposes, said facility comprising:
a computer,
a network interface card device for coupling to said computer, said network interface card device including an interface for coupling to and communicating with said computer, a processor device coupled to said interface, a coupler coupled to said processor device, and an antenna coupled to said processor device, and
a subscriber identify module (SIM) card for coupling to said coupler of said network interface card device, and to connect to network systems.

2. The facility as claimed in claim 1, wherein said network interface card device is a wireless network interface card device.

3. The facility as claimed in claim 1, wherein said network interface card device includes a wireless module coupled between said processor device and said antenna.

4. The facility as claimed in claim 1 further comprising a local area network system including an access or device to connect and communicate with said network interface card device via said antenna.
